(19) United States
(12) Patent Application Publication
(10) Pub. No.: US 2011/0008139 A1
(43) Pub. Date: Jan. 13, 2011

(54) TRAILER FOR WATERCRAFT AND WATERCRAFT LIFTS

(76) Inventors: Kenneth Edwards Hey, Bellevue, WA (US); Randall T. Wilson, Newcastle, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 12/814,252

(22) Filed: Jun. 11, 2010

Related U.S. Application Data
(60) Provisional application No. 61/186,881, filed on Jun. 14, 2009.

(51) Int. Cl. B60P 3/10; B60P 1/02

(52) U.S. Cl. 414/495; 414/812

(57) ABSTRACT

A trailer without an integrated drive system with an independent hydraulic and charging system, capable of moving a boat, boat lift or combination of boat lift and boat. Trailer includes an open-forked frame, vertically translating rear wheels, vertically translating tongue, boat supports, a complete hydraulic system, and a forward mounted landing foot. The rear wheels and tongue being vertically moveable to pick up or remove a boat, and/or a boat lift.

### CROSS-REFERENCE TO RELATED APPLICATION

This application claims the benefit of U.S. Provisional Application No. 61/186,881, filed Jun. 14, 2009.

### TECHNICAL FIELD

The invention generally relates to and apparatus and method for launching, retrieving, moving, and unloading boats and boat lifts.

### BACKGROUND OF THE INVENTION

It is well known that boats and boat lifts need to be taken in and out of the water, transported on land, and be unloaded on land.

It is desirable to utilize boat launching ramps, since these are common in a shoreline region. Current designs exist for the above functionality using a boat ramp, such as U.S. Pat. Nos. 7,628,564, 6,341,793 and 5,857,823, but require a high level of training, and are very expensive. Much of the cost and complexity is associated with the drive system integrated into the device, therefore, there is a need for a hydraulic trailer that utilizes a standard existing tow vehicle, and has simple controls that do not require much training. U.S. Pat. No. 4,236,859 discloses a device designed for launching, retrieving and moving boats, but it is designed for a specially designed dock verses a launch ramp.

Use of a boat ramp is often not possible for boats approximately 30 feet long or more, since a standard trailer can bottom out on the apex of the boat ramp. U.S. Pat. Nos. 7,455,310 and 4,395,185 disclose the use of a pivoting trailer tongue, designed to lower the front of the trailer for shallow water loading, rather than raise it as required to get over the apex of the ramp. Keeping the boat level while extracting from a launch ramp is desirable since the boat does not need to be tied down, and the interior of the boat is less disturbed. U.S. Pat. No. 7,628,564 solves the apex clearance problem by having a pivot substantially in the middle of the frame, but requires significant hydraulic cylinders to operate. U.S. Pat. No. 4,801,153 also has a hinged middle of the frame, which is used for launching instead of apex clearance.

Boat lifts are currently launched and recovered from the water using a flatbed trailer. The boat lift would need to be loaded and tied down carefully, since a flatbed trailer has no positioning features. However, it has not been practical nor safe to remove a boat lift with a boat on the boat lift. U.S. Pat. No. 4,801,153 discloses a design for adding wheels to a boat lift, but requires the wheels to be removed, and cannot accommodate a boat on the lift while the lift is being removed from the water.

Operation in as shallow water as possible enables use of a trailer in more conditions. U.S. Pat. No. 5,857,823 discloses rear wheels straddling the frame of a trailer, which is shallower than having the wheels under the frame. Wheels mounted on the outboard side of the frame would also be as shallow, but would induce a torque load into the frame.

Positioning boats fore and aft using a bow stop greatly simplifies loading, but current designs are not easily adjustable for use with multiple boat designs. U.S. Pat. Nos. 7,455,310, 7,614,635 and 4,801,153 disclose use of a fixed bow stop.

Protecting the hull of a boat requires proper bunks/bunk support to avoid damage during the harsh use of loading and unloading as well as abrasive sea life growth. It is desirable to have bunks compatible with many hull shapes but common design requires manual adjustment and a skilled operator. U.S. Pat. No. 7,628,564 discloses the use of air-pressurized bunks for universal use with little to no adjustment but is vulnerable to puncture and requires an air source to pressurize the bunks. Non-pneumatic rubber-capped bunks have been used on boat lifts such as U.S. Pat. No. 6,830,410.

A problem with the current universal boat hoisting trailer is that the bunks/bunk supports are not adjustable laterally, since certain boat hulls require different bunk widths. This is especially important for supporting catamaran hulls since the hulls are narrower than a V-hull. Many current bunk shapes are either flat, which isn't conducive to hulls with different deadrises, or round, which concentrates the pressure on the hull more than a properly-fitting flat shape. Pivoting flat bunks accommodate multiple deadrises, but their discreet pivot points can concentrate pressure on the hull and the pivots can require more maintenance. Pivots also take up valuable draft clearance for shallow water use.

### BRIEF SUMMARY OF THE INVENTION

This summary of the invention section is intended to introduce the reader to aspects of the invention and is not a complete description of the invention. Particular aspects of the invention will be pointed out in claims stated below—such claims alone will demarcate the scope of the invention.

The present invention is generally directed for moving, launching, retrieving, and placing a boat and/or a boat lift. More particularly, an open-forked trailer frame is raised and lowered using rear wheels mounted to a pivoting arm, and a pivoting forward trailer tongue.

A boat and/or boat lift is retrieved from the water by backing the assembly down a launch ramp into the water with sufficient depth to float a boat and/or a boat lift on to support bunks mounted to the trailer frame. An adjustable bow stop is positioned to prepare for proper loading of a boat. For boat lift retrieval, a boat lift bow stop is positioned to do the same. The frame is at a lowered first position to load the boat and/or boat lift. Then the rear wheels are translated downward to a deployed second position to raise the rear of the trailer to securely rest the boat and/or boat lift on the bunks, and to keep the boat/and or boat lift more level. This eliminates the need to secure the boat/and or boat lift to the trailer. A towing vehicle tows the trailer to near the top of the launch ramp, and the tongue is rotated to a second raised position to lift the front of the trailer to give additional clearance between the apex of the launch ramp to the bottom of the trailer.

To remove the boat from the trailer, an operator sets out support blocks under the hull of the boat, and lowers the frame by retracting the rear wheels to a lowered first position, and rotating the tongue to a lowered first position. This lowers the boat onto the support blocks and retracts the boat supports of the trailer from the hull of the boat. The trailer is then towed from the location leaving the boat behind on the support blocks.

To remove the boat lift from the trailer with or without a boat on the boat lift, an operator deploys legs from the boat lift, and lowers the trailer frame by retracting the rear wheels to a lowered first position, and rotating the tongue to a lowered first position. This rests the legs of the boat lift on the ground and retracts the frame from the structure of the boat lift. The trailer is then towed from the location leaving the boat lift (with or without the boat on it) behind.

The hydraulic cylinders are powered by a hydraulic power unit mounted to the front of the trailer frame. A battery supplies power to the hydraulic power unit. A solar panel charges the battery. This system allows the trailer to be used by a standard tow vehicle, thus saving cost, space and maintenance.

The trailer is attached to a tow vehicle using a standard pintle hitch, or a 5^{th} wheel hitch. To remove the trailer from the tow vehicle, a forward foot is lowered and secured, and the tongue is rotated upward until the load is eliminated from the hitch to allow uncoupling.

In the preferred embodiment, the boat supports comprise longitudinal bunks of a non-inflatable soft material, such as rubber, mounted directly to the frame of the trailer to minimize their height. The bunks are shaped to accept a V-hull or catamaran. In an alternative embodiment of the trailer, the lateral positioning of the bunk can be adjusted for additional flexibility by use of telescoping sections in the front of the forks of the frame.

The boat lift is secured to the frame fore and aft by a shallow index features on the frame that are positioned on either side of the boat lift cross frame member. The boat lift is secured laterally by indexing the side rails of the boat lift to the inside of the trailer frame forks.

In the preferred embodiment, the rear wheels comprise of a pair of wheels on each side, positioned to straddle the trailer fork structure to allow the trailer to lower to a minimum height, and to balance the applied load into the fork of the trailer.

In the preferred embodiment, the hydraulic cylinders are synchronized to simplify operation, and to prevent undesirable twisting loading of unsynchronized wheel positions. The hydraulics are controlled with a pendant controller or remote control with a first up/down control for the forward tongue, and a second up/down control for the rear wheels.

### BRIEF DESCRIPTION OF THE DRAWINGS

FIG. 1 is a side elevational view of a trailer according to the present invention supporting a boat lift with a boat on the boat lift positioned on land without a tow vehicle shown.

FIG. 2 is a rear elevational view of the trailer of FIG. 1.

FIG. 3 is a top isometric view of the trailer of FIG. 1 without a boat lift or boat loaded payload on the trailer.

FIG. 4 is a top isometric view of the trailer of FIG. 1 without a payload on the trailer with an adjustable bow stop moved to a position compatible with shorter boats.

FIG. 5 is a side elevational view of the trailer of FIG. 1 without a payload on the trailer and with the trailer in the fully lowered position.

FIG. 6 is a side elevational view of the trailer of FIG. 1 without a payload on the trailer and with the trailer in the fully raised position.

FIG. 7 is a top isometric view of the trailer of FIG. 1 without a payload on the trailer with the adjustable bow stop pivoted into a position compatible with shorter boats and with the boat lift fore/aft positioning stops deployed to accept the loading of a boat lift.

FIG. 8 is a top plan view of the trailer of FIG. 1 loaded with a floating boat lift without a boat in the boat lift, with the boat lift fore/aft positioning stops shown deployed.

FIG. 9 is an enlarged rear elevantional view of the trailer of FIG. 1 loaded with a catamaran hull boat showing the fitment of the boat's inner hull on outer surfaces of the trailer bunks.

FIG. 10 is an enlarged rear elevantional view of the trailer of FIG. 1 loaded with a V-hull boat showing the fitment of the boat's inner hull on inner surfaces of the trailer bunks.

FIG. 11 is an enlarged top isometric view of the trailer of FIG. 1 using an alternative embodiment of the adjustable bow stop of FIG. 7.

FIG. 12 is an enlarged top isometric view of the trailer of FIG. 1 showing boat lift locating features which allow hauling of a boat lift as well as clearance for boat hulls to avoid damaging contact.

FIG. 13 is a top isometric view of an alternative embodiment of the trailer of FIG. 1 using a telescoping adjustable frame to accommodate multiple boat hull sizes.

FIG. 14 is an enlarged top isometric view of the forward end portion of the trailer of FIG. 1 showing the trailer controller.

FIG. 15 is an enlarged rear elevational view of an alternative embodiment of the trailer of FIG. 1 having left and right side single cantilevered rear wheels.

FIG. 16 is block diagram of a power supply system for the trailer of FIG. 1.

### DETAILED DESCRIPTION OF THE INVENTION

The present invention is generally directed to a trailer (13) and method for loading, launching, landing and retrieving a watercraft and/or watercraft lift to facilitate the transition between a body of water and land, and storage on land.

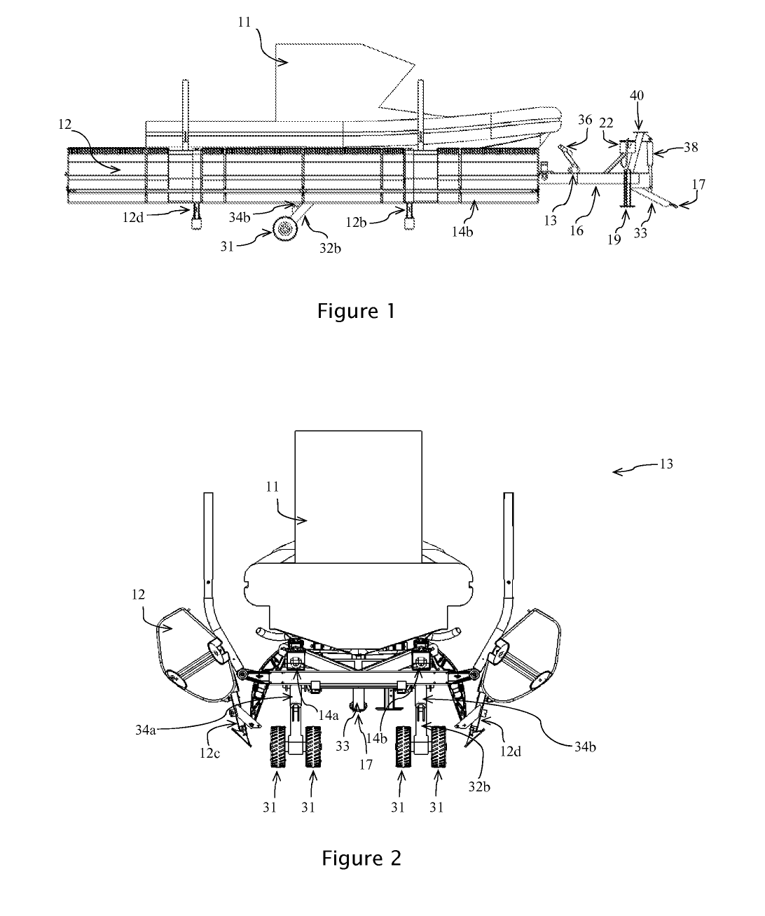

A trailer (13) of the present invention is shown in FIGS. 1 and 2. The trailer is depicted in a fully loaded state with both a watercraft (11) supported by a floating watercraft lift (12) which rest directly upon the trailer. The trailer (13) may also carry the watercraft directly resting upon the trailer without a watercraft lift being present, thus the trailer provides for increase versatility since it can be used to launch and retrieve, as well as store, either a watercraft by itself, a watercraft lift by itself, or a watercraft lift supporting a watercraft. The trailer (13) is intended for use on land for towing behind a conventional tow vehicle (not shown), and the illustrated configuration would be appropriate for towing both the watercraft and watercraft lift to or from storage at a land-based location.

In FIG. 2 the watercraft lift (12) is depicted loaded and straddling the trailer (13) and shows the side-to-side location of the watercraft lift relative to the trailer. The watercraft (11) is shown riding atop the watercraft lift (12) during land transport similar to its position while the watercraft lift is waterborne.

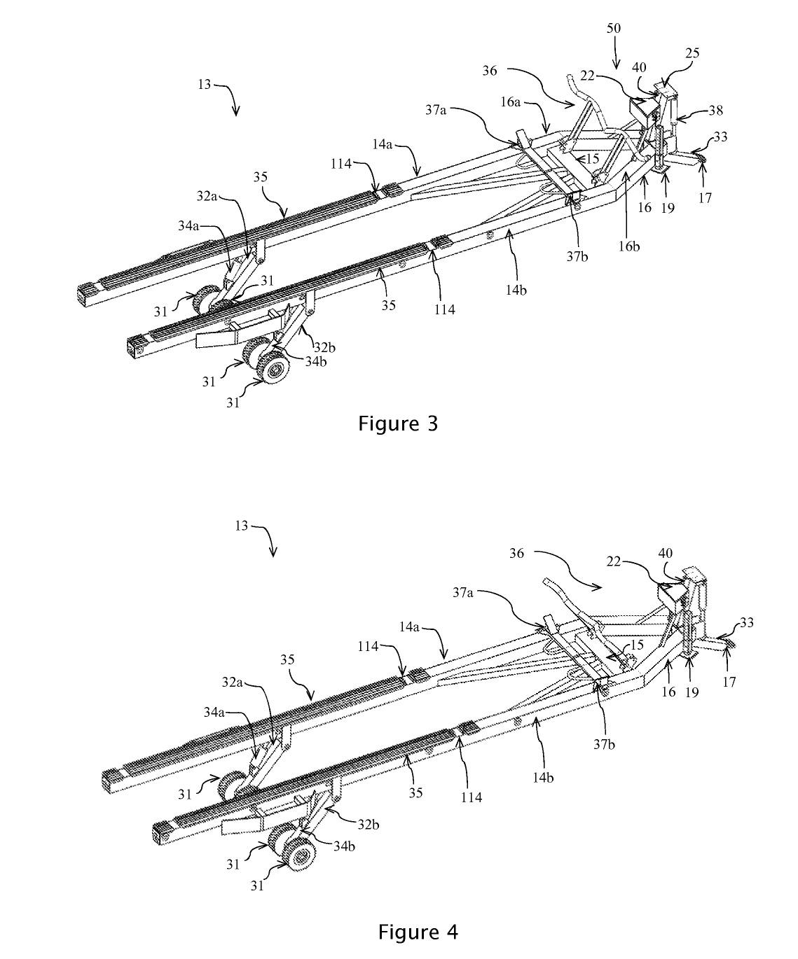

As best illustrated in FIGS. 2 and 3, the trailer (13) has substantially rigid left and right side longitudinally extending side frame members (14a) and (14b), respectively, defining a rearwardly opened, forked frame without the forward and rearward portions of the side frame members being pivotally interconnected. The side frame members are rigidly joined together at a forward end of the trailer by a cross-member 15 and a V-shaped forward frame (16) to provide a non-pivoting, rigid frame structure. The trailer (13) has left and right side downwardly and rearwardly extending wheel supports (32a and 32b) which each have a pair of wheels (31) rotatably attached to a distal end thereof. The proximal ends of the left and right side wheel supports (32a and 32b) are pivotally attached to the rearward end portions of the left and right side frame members (14a and 14b), respectively. Left and right side hydraulically actuated cylinders (34a and 34b) have one end attached to the left and right side frame members (14a and 14b), respectively, and an opposite end attached to the left and right side wheel supports (32a and 32b), respectively, such that extension of the left and right side hydraulically actuated cylinders rotates the left and right side wheel supports forward (i.e., counterclockwise when viewed from the right side of the trailer) to raise the rearward end portion of the frame structure of the trailer relative to the ground, and retraction of the left and right side hydraulically actuated cylinders rotates the left and right side wheel supports rearward (i.e., clockwise when viewed from the right side of the trailer) to lower the rearward end portion of the frame structure of the trailer relative to the ground. The left and right side hydraulically actuated cylinders (34a and 34b) have sufficient strength to vertically raise and lower the rearward end portion of the frame structure of the trailer between a maximum raised position and a minimum lowered position when loaded with its maximum rated payload, which typically would include the watercraft (11) and the floating watercraft lift (12).

It is preferred, although not required, to simultaneously operate the left and right side hydraulically actuated cylinders (34a and 34b) and synchronously rotate the left and right side wheel supports forward and rearward so as to keep the construction and operation of the controls for the trailer (13) simple and easy. This also minimizes costs and the risk of operator error that could cause the left and right side hydraulically actuated cylinders to individually extend and/or retract and thereby possibly result in one side of the frame structure of the trailer becoming so much lower than the other that the lateral tilting of the trailer causes the payload to shift laterally on the trailer or even slide laterally off of the trailer.

A forwardly extending tongue (33) has a proximal end pivotally attached to a forward end of the V-shaped forward frame (16) and extends forward thereof. A distal end of the tongue (33) has a hitch (17) attached thereto which can be selectively connected to and disconnected from a mating hitch member of a tow vehicle (not shown). An upwardly extend post (40) is fixedly attached to the forward end of the V-shaped forward frame, and a hydraulically actuated cylinder (38) has one end attached to the post and an opposite end attached to the tongue (33), such that extension of the hydraulically actuated cylinder rotates the tongue downward to raise the forward end portion of the frame structure of the trailer relative to the ground when the hitch (17) is attached to the tow vehicle, and retraction of the hydraulically actuated cylinder rotates the hitch upward to lower the forward end portion of the frame structure of the trailer relative to the ground when the hitch is attached to the tow vehicle. The hydraulically actuated cylinder (38) has sufficient strength to vertically raise and lower the forward end portion of the frame structure of the trailer when attached to the tow vehicle trailer between a maximum raised position above an appropriate towing height at which the trailer is towed (typically with the tongue extending generally horizontally) and a minimum lowered position below the towing height while the trailer is loaded with its maximum rated payload, which typically would include the watercraft (11) and the floating watercraft lift (12).

The left and right side hydraulically actuated cylinders (34a and 34b) and the hydraulically actuated cylinder (38), as well as the construction of the frame structure of the trailer and other components, are designed to carry and operate under a payload where the watercraft (11) is 16,000 to 24,000 pounds or more and the watercraft lift (12) is 8,000 pounds or more, with a maximum payload rating of 40,000 pounds.

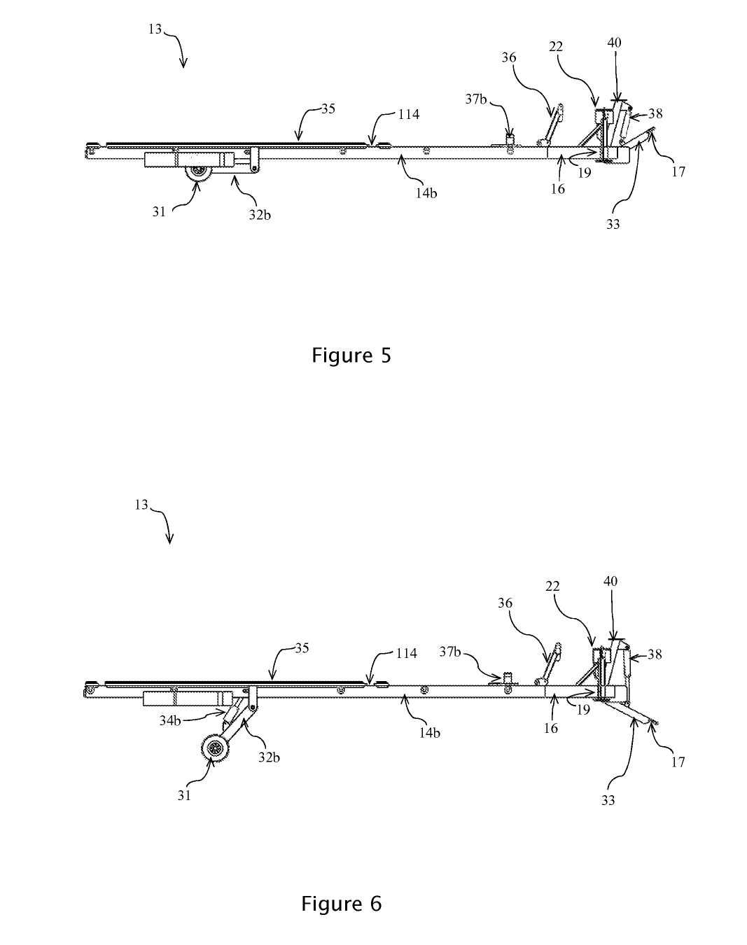

In FIG. 6, the trailer (13) is shown with the left and right side hydraulically actuated cylinders (34a and 34b) and the hydraulically actuated cylinder (38) operated to both raise the rearward end portion of the frame structure of the trailer relative to the ground to the maximum raised position and raise the forward end portion of the frame structure of the trailer relative to the ground to the maximum raised position when the hitch (17) is attached to the tow vehicle (not shown). In so doing, the frame structure of the trailer is maintained in an elevated orientation relatively parallel to the ground and well above the ground clearance height that exists when being towed by the tow vehicle. This provides the maximum ground clearance and facilitates positioning the trailer with the tow vehicle so that the trailer is over keel or other blocks and then operating the left and right side hydraulically actuated cylinders (34a and 34b) and the hydraulically actuated cylinder (38) to lower the frame structure of the trailer relative to the ground such as shown in FIG. 5 so that the watercraft lift (12) and/or watercraft (11) is lowered to a position resting a top the blocks and whereupon hull stands may be placed in position to stabilize the watercraft lift or watercraft. The left and right side hydraulically actuated cylinders (34a and 34b) and the hydraulically actuated cylinder (38) may then be operated to again raise both the rearward end portion of the frame structure of the trailer and the forward end portion of the frame structure of the trailer relative to the ground sufficiently toward the maximum raised position that the tow vehicle may pull the trailer forward leaving the watercraft lift and/or watercraft resting on the blocks and stands.

With the watercraft lift (12) of the design illustrated in FIGS. 1 and 2, the watercraft lift has two left side downwardly adjustable legs (12c) and two right side downwardly adjustable legs (12d) which may be adjusted downward below the lowest other portions of the watercraft lift. With the legs (12c and 12d) adjusted downward and the trailer (13) at an intended storage location for the watercraft lift, the left and right side hydraulically actuated cylinders (34a and 34b) and the hydraulically actuated cylinder (38) may be operated to lower the frame structure of the trailer relative to the ground sufficiently to rest the legs of the watercraft lift on the ground and to future lower the frame structure of the trailer so that it is no longer is supporting the watercraft lift. The tow vehicle may then pull the trailer forward leaving the watercraft lift and the watercraft resting on the watercraft lift stored at the intended storage location without the need to use bocks or stands.

It is noted that while the trailer (13) is aptly suited for use to store the watercraft lift and/or watercraft on bocks and stands, and for use to store the watercraft lift on its adjustable legs, the trailer has a sufficiently simple design and thus low cost of construction that the trailer may be economically used as a platform for storage of the watercraft lift and/or watercraft. By storing the watercraft lift and/or watercraft on the trailer (13), extremely rapid deployment of the watercraft lift and/or watercraft is possible since it is not necessary to bring the trailer to the watercraft lift and/or watercraft and again position the watercraft lift and/or watercraft on the trailer before towing it to the launch ramp for launching the watercraft. This can be extremely important in military and security applications were deploying watercraft quickly can avoid damage to the watercraft from enemy fire and potential loss of life.

In FIG. 5, the trailer (13) is depicted with the left and right side hydraulically actuated cylinders (34a and 34b) and the hydraulically actuated cylinder (38) operated to both lower the rearward end portion of the frame structure of the trailer relative to the ground to the minimum lowered position and lower the forward end portion of the frame structure of the trailer relative to the ground to the minimum lowered position when the hitch (17) is attached to the tow vehicle (not shown). In so doing, the frame structure of the trailer is maintained in an elevated orientation relatively parallel to the ground and well below the ground clearance height that exists when being towed by the tow vehicle. This provides the minimum ground clearance and lowest position of the frame structure of the trailer to facilitate launching and retrieving the watercraft lift (12) and/or watercraft (11) in shallow water using the tow vehicle. This minimum ground clearance for the trailer also facilitates backing the empty trailer underneath a payload to be loaded when on blocks on land.

The operation of the left and right side hydraulically actuated cylinders (34a and 34b) and the hydraulically actuated cylinder (38) when the hitch (17) is attached to the tow vehicle also provides control of the forward/rearward pitch of the frame structure of the trailer (13) for towing and thereby allow achievement of an improved load balance since the wheels (31) and the wheel supports (32a and 32b) carry a majority of the payload weight.

The trailer (13) included a forward downwardly adjustable support stand (19) used to support the forward end of the trailer when the hitch (17) is not attached to the tow vehicle. While a conventional jack could be used to raise and lower the forward end of the trailer, in the illustrated embodiment the adjustable support stand (19) is a simple telescoping device with a fixed member fixedly attached to the V-shaped forward frame (16) and an extendible member telescopically received therein and adjustably held in place in any one of a plurality of extended positions by a pin. To raise and lower the forward end of the trailer so the support stand can be adjusted, while the hitch (17) is still attached to the tow vehicle, the hydraulically actuated cylinder (38) is operated to rotate the tongue (33) downward or upward to raise or lower, respectively, the forward end portion of the frame structure of the trailer relative to the ground. When the trailer is at the desired height, the support stand (19) is adjusted so that a foot at the lower end thereof contact the ground, and then the hitch (17) is unlatched so that it is free to be disconnected from the tow vehicle and the hydraulically actuated cylinder (38) is operated to rotate the tongue upward and disengage the hitch from the tow vehicle. The process can be reversed to reconnect the trailer to the tow vehicle. Thus, the expense of a manual jack and the time required to operate it when disconnecting or connecting the trailer to the tow vehicle are avoided. Further, when carrying the size payloads for which the trailer (13) is rated, operating a hand-crank jack to raise the frame structure of the trailer would be difficult, if not impossible, and would require use of large reduction gears in the jack and hence would be unacceptably slow and consume too much time and energy, especially where rapid and easy deployment of the watercraft lift and/or watercraft is important.

While the left and right side hydraulically actuated cylinders (34a and 34b) and the hydraulically actuated cylinder (38) may be operated by pressurized hydraulic fluid, such as hydraulic oil, the fluid may also be air or another gas supplied under pressure. An alternative embodiment could use other power mechanisms to provide the function supplied by the left and right side hydraulically actuated cylinders (34a and 34b) and the hydraulically actuated cylinder (38), such as another type of linear actuation device.

While the left and right side hydraulically actuated cylinders (34a and 34b) and the hydraulically actuated cylinder (38) could be coupled to a supply of pressurized hydraulic fluid supplied by a system on the tow vehicle, the illustrated embodiment of the trailer (13) utilized a self-contained and pressurized hydraulic fluid system (50) (illustrated in the block diagram of FIG. 16) located onboard the trailer and operable independent of the tow vehicle so that the tow vehicle and no other source of pressurized hydraulic fluid or power is needed. The trailer's hydraulic fluid system (50) includes a power module (52) that is mounted on the V-shaped forward frame (16) of the trailer. For ease of illustration in FIG. 16 only a single cylinder is shown and is representative of the three cylinders (34a/34b/38) utilized. As discussed above, it is preferred, although not required, to simultaneously operate the left and right side hydraulically actuated cylinders (34a and 34b) for synchronous extension and retraction of the left and right side hydraulically actuated cylinders (34a and 34b).

The power module (52) is positioned in a box (22) attached to the post (40). The module (52) generally includes a hydraulic fluid pump (54) that exchanges a hydraulic fluid with a reservoir (55), and is capable of delivering the fluid under pressure to a selected on of the cylinders (34a/34b/38) through a solenoid-actuated up valve (56) when the selected cylinder is being extended. A solenoid-actuated down valve (57) may be actuated to release pressurized fluid from the selected cylinder when the cylinder is being retracted. A flow control valve (58) may be included to control the rate at which the cylinder is extended or retracted. The pump (54) is further coupled to a direct current (DC) motor (59) that receives current from a DC power source, such as a battery (60). The battery may be electrically coupled to the DC motor through a solenoid relay (61), or other power relay devices. The battery may further be electrically coupled to a solar panel (62) mounted atop the post (40) that is capable of recharging the battery when the solar panel is exposed to solar radiation.

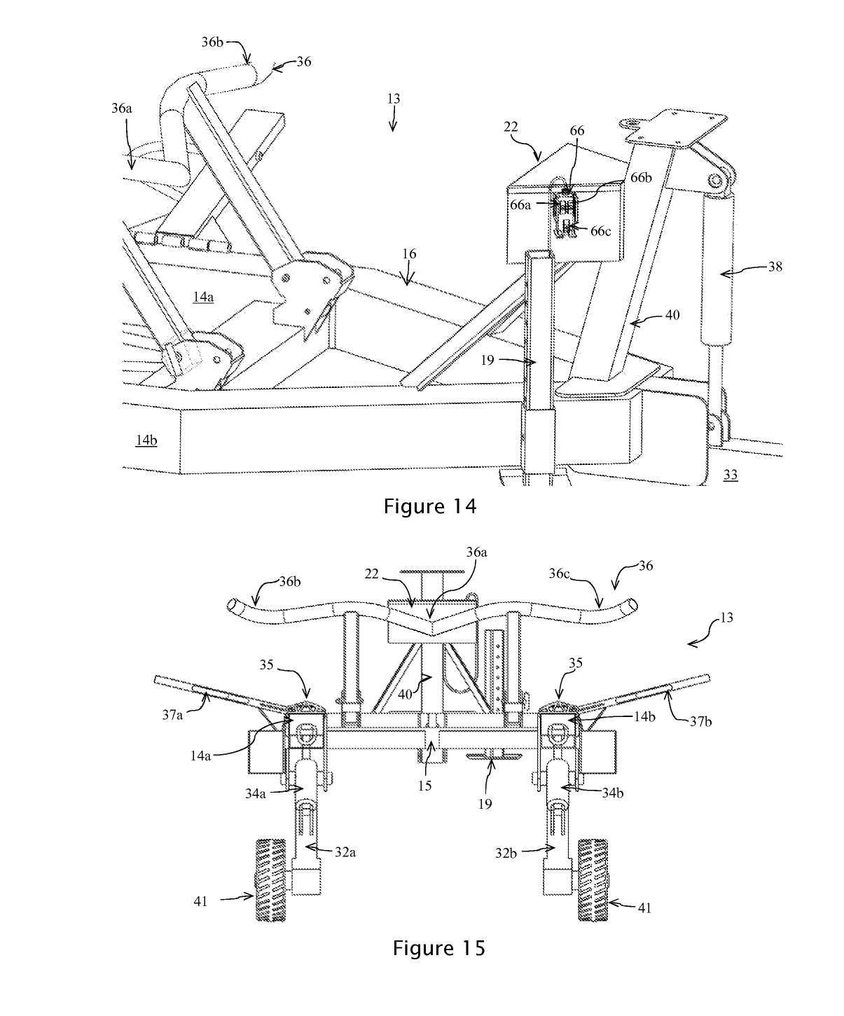

The module (52) further includes a control unit (65) that is operatively coupled to the up valve (56) through an up solenoid (61a), the down valve (57) through a down solenoid (61b), and the solenoid relay (61) to control the operation of these elements. The hydraulic fluid system (50) includes a handheld controller (66), shown in FIG. 14, that allows an operator to manually control the control unit (65). In an alternative embodiment, the controller (66) may be a wireless transmitter (not shown) and the control unit may have the capability of receiving wireless signals from a wireless transmitter to control the control unit. The controller (66) of FIG. 14 includes three manually operable switches (66a, 66b and 66c). The switch (66a) is used to selectively extend and retract the hydraulically actuated cylinder (38) which rotates down and up the tongue (33) to raises and lower the forward end portion of the frame structure of the trailer relative to the ground when the hitch (17) is attached to the tow vehicle or to raise and lower the tongue to control the position of the hitch when connecting or disconnecting the trailer from the tow vehicle. The switch (66b) is used to selectively simultaneously extend and retract the left and right side hydraulically actuated cylinders (34a and 34b) which rotates forward and rearward the left and right side wheel supports (32a and 32b) to raise and lower the rearward end portion of the frame structure of the trailer relative to the ground. The switch (66c) is used to selectively simultaneously extend and retract the hydraulically actuated cylinder (38) and the left and right side hydraulically actuated cylinders (34a and 34b) to raise and lower at the same time with a single switch both the forward and rearward end portions of the frame structure of the trailer relative to the ground when the hitch (17) is attached to the tow vehicle.

With the above-described arrangement, the left and right side hydraulically actuated cylinders (34a and 34b) and the hydraulically actuated cylinder (38) are powered by the self-contained and pressurized hydraulic fluid system (50) which is located onboard the trailer and operable independent of the tow vehicle and any external power source or source of pressurized hydraulic fluid. This allows the trailer (13) to be used by a standard tow vehicle, thus saving cost, space and maintenance.

An adjustable bow stop (36) has a pair of support members which are each pivotally attached at a lower end to the cross-member 15. The bow stop is shown in FIG. 3 rotated into a forward most position for positioning longer watercraft on the trailer (13) when loaded on the trailer without a watercraft lift. The bow stop is shown in FIG. 4 rotated into a rearward most position for positioning a shorter watercraft on the trailer (13) when loaded on the trailer without a watercraft lift. When a shorter watercraft is to be loaded for land transport or land storage, the adjustable bow stop (36) is moved rearward as shown in FIG. 4 to better position the center of gravity and avoid excessive weight on the tongue (33).

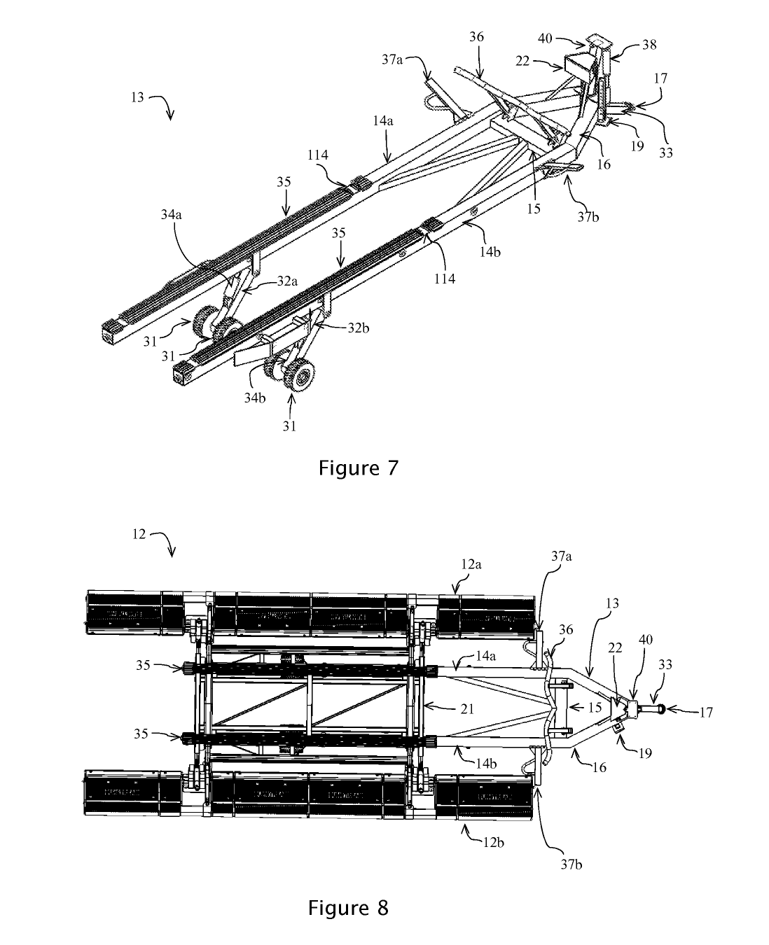

As best illustrated in FIG. 7, the trailer (13) includes left and right side positioning members (37a and 37b) which each have a proximal end pivotally attached to the left and right side frame members (14a and 14b), respectively. The left and right side positioning members are shown rotated inward in FIGS. 3 and 4 so as to be out of the way when not being used to assist alignment of the watercraft lift (12) on the trailer, such as when the trailer is being used to carry a watercraft (11) positioned directly on the frame structure of the trailer. In FIGS. 7 and 8, the left and right side positioning members (37a and 37b) are shown rotated outward into a deployed position to provide a positive means of properly locating the center of gravity of the watercraft lift when being loaded onto the trailer so as to provide for proper trailering. As best illustrated in FIG. 8, the left and right side positioning members (37a and 37b) each include a rearwardly projecting portion with an outer side guide portion that abuts against the inner side of the left and right side floats (12a and 12b), respectively, of the watercraft lift (12) to assist side-to-side location of the forward end of the watercraft lift on the trailer and limit the lateral movement thereof on the trailer during towing.

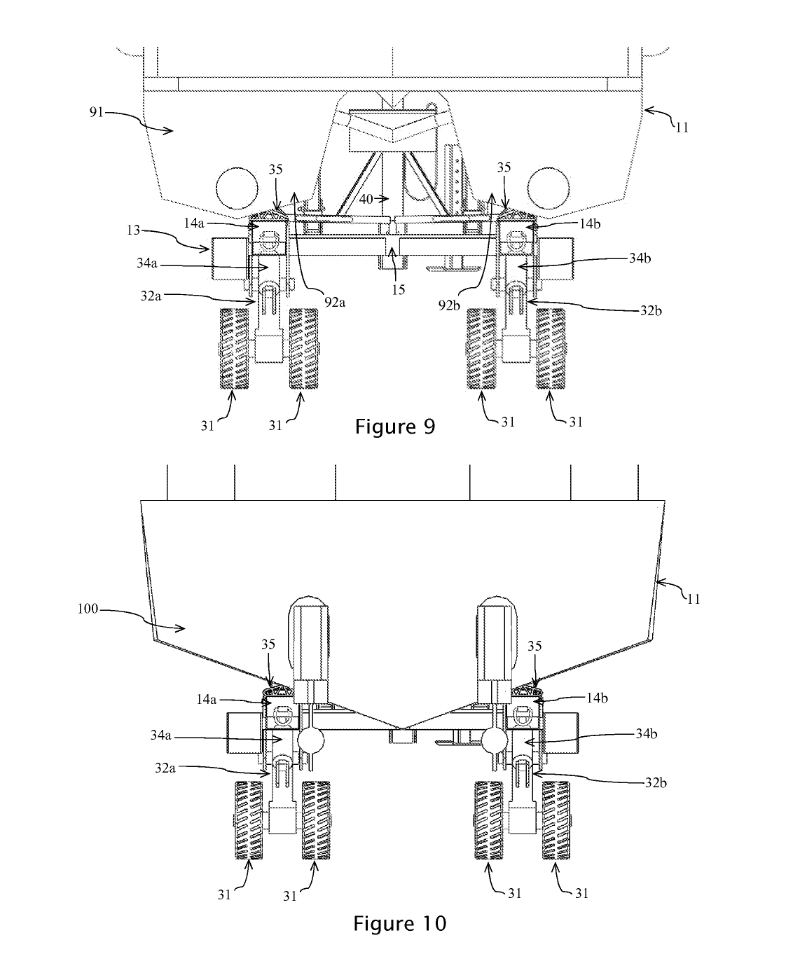

As perhaps best illustrated in FIGS. 9, 10, 12 and 15, affixed directly to and atop each of the left and right side frame members (14a and 14b) and extending along their length starting at a position rearward of the bow stop (36), is trailer bunk or cushioning member (35). This provides a direct-mounting to the trailer side frame members to provide improved distribution of the pressure from the payload. The cushion member (35) has a generally triangular cross-sectional shape, with a substantially flat downwardly and outwardly sloping laterally outward facing surface, and a substantially flat downwardly and laterally inward sloping inwardly facing surface. As illustrated in FIG. 9, where the watercraft (11) is depicted as a catamaran hull boat (91), the laterally outward facing surface of the cushioning member (35) affixed to the left side frame member (14a) supportingly contacts a correspondingly sloping laterally inward facing surface of the left hull portion (92a) of the catamaran hull boat, and the laterally outward facing surface of the cushioning member (35) affixed to the right side frame member (14b) supportingly contacts a correspondingly sloping laterally inward facing surface of the right hull portion (92b) of the catamaran hull boat.

As illustrated in FIG. 10, where the watercraft (11) is depicted as a V-hull boat (100), the laterally inward facing surface of the cushioning member (35) affixed to the left side frame member (14a) supportingly contacts a correspondingly sloping laterally outward facing surface of the left side of the hull of the V-hull boat, and the laterally inward facing surface of the cushioning member (35) affixed to the right side frame member (14b) supportingly contacts a correspondingly sloping laterally outward facing surface of the right side of the hull of the V-hull boat.

With the same cushioning member (35), the trailer (13) can carry both a catamaran hull boat (91) or a V-hull boat (100) and provide superior distribute of the pressure from the weight of the watercraft.

To facilitate a secure transport of the watercraft lift (12) on the trailer (13), the trailer includes an upwardly opening U-shaped member (114) affixed directly to and atop each of the left and right side frame members (14a and 14b) as shown in FIG. 12. The U-shaped members (114) are oriented to each provide a laterally extending channel and located at corresponding positions on the left and right side frame members (14a and 14b) so as to be in lateral alignment. The U-shaped members are sized to receive therein a transversely extending lower frame member of the watercraft lift (12), such as the front cross-beam (21) of the watercraft lift shown in U.S. Pat. No. 6,823,809, and help hold the watercraft lift in position when loaded on the trailer. The U-shaped members (114) are each positioned in a gap formed in the cushioning member (35) affixed to the left or right side frame member (14a or 14b) to which the U-shaped member is attached. A forward portion of the cushioning member is positioned adjacent to and forward of the U-shaped member, and a rearward portion of the cushioning member is positioned adjacent to and rearward of the U-shaped member, and the U-shape member extends upward to a height lower than the apex of the cushioning member between its inward and outward facing surfaces. As such, the U-shaped member is sized to receive and securely hold therein the transversely extending lower frame member of the watercraft lift (12) when the trailer carries a watercraft lift, but is recessed sufficiently to avoid contact with the hull of a watercraft when the trailer carries a watercraft with its hull resting directly on the cushioning members (35).

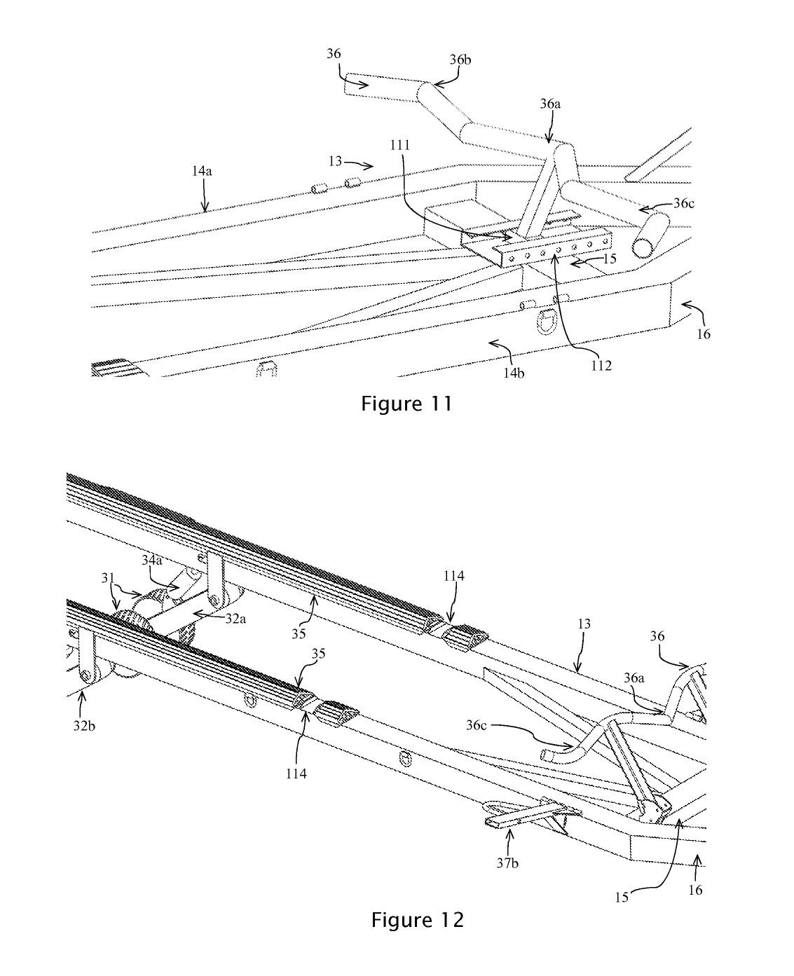

A second embodiment of the adjustable bow stop (36) is shown in FIG. 11. In this embodiment, the bow stop has a foot (111) slidably positionable within a forward/rearward longitudinally extending track or channel (112). The longitudinal position of the foot (111) and hence the longitudinal position of the bow stop (36) is set by sliding the foot to the desired position in the channel (112), and then adjustably positioning it there against further movement by pins or set screws that each extend through one of a plurality of apertures.

The shape of the bow stop (36) is design to engage the bow of the watercraft (11), whether it be the bow of the hull of a catamaran hull boat (91) or a V-hull boat (100). As best illustrated in FIG. 11, this is accomplished by providing the bow stop with a transversely extending upper portion with a central forwardly projecting and rearwardly opening V-shaped portion (36a) that is sized to receive the single bow thereagainst of the V-hull boat, and left and right side forwardly projecting and rearwardly opening V-shaped portions (36b and 36c), on opposite sides of the central V-shaped portion, that are sized and spaced apart to receive the spaced-apart left and right bows thereagainst of the left and right hull portions of the catamaran hull boat.

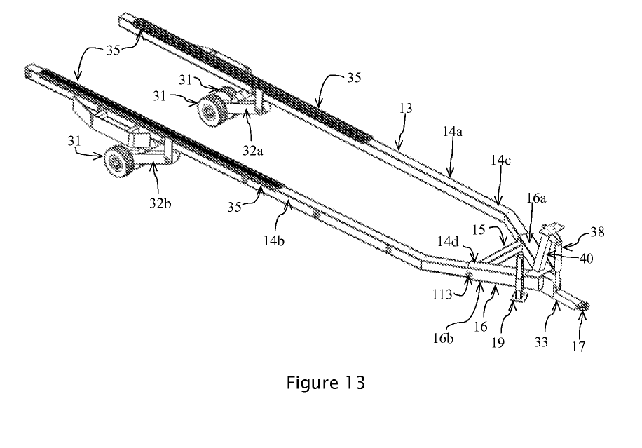

An alternative frame design for the trailer (13) is shown in FIG. 13. In this embodiment, the left and right side frame members (14a and 14b) have forwardly converging forward end portions (14c and 14d), respectively. Further, the V-shaped forward frame (16) has rearwardly diverging left and right side channel members (16a and 16b) which telescopically receive therein the forwardly converging forward end portions (14c and 14d), respectively, of the left and right side frame members. Since the left and right side frame members (14a and 14b) are disconnected except by the V-shaped forward frame (16), the further their forward end portions (14c and 14d) extend into the channel members (16a and 16b) of the V-shaped forward frame (16), the closer the portions of the left and right side frame members (14a and 14b) extending rearward of the forward end portions (14c and 14d) are positioned together. This allows the spacing between the left and right side frame members (14a and 14b) extending rearward of the forward end portions (14c and 14d) and to which the cushioning bunks (35) are mounted to be adjustably, laterally spaced apart to better accommodate watercrafts (11) and the floating watercraft lifts (12) of different widths. Thus, while the cushioning bunks (35) are designed to handle a large range of watercraft hull shapes and sizes, if a watercraft hull or watercraft lift falls outside this range, the width of the trailer's left and right side frame members (14a and 14b) and hence the spacing between the cushioning bunks thereon that provide the support can be adjusted as needed. The forward end portions (14c and 14d) of the left and right side frame members (14a and 14b) are adjustably fixed in position within the channel members (16a and 16b) of the V-shaped forward frame (16) by a plurality of locating pins or set screws (113).

The pair of wheels (31) attached to the distal end of the left side wheel support (32a) are spaced apart sufficiently such that when the left side hydraulically actuated cylinder (34a) is operated to rotate the left side wheel support fully rearward, the wheels will straddle the left side frame member (14a), and the pair of wheels (31) attached to the distal end of the right side wheel support (32b) are spaced apart such that when the right side hydraulically actuated cylinder (34b) is operated to rotate the right side wheel support fully rearward, the wheels will straddle the right side frame member (14b), as apparent from FIG. 5. In such manner, the left and right side hydraulically actuated cylinders (34a and 34b) can be operated to lower the rearward end portion of the frame structure of the trailer to the lowest possible minimum lowered position.

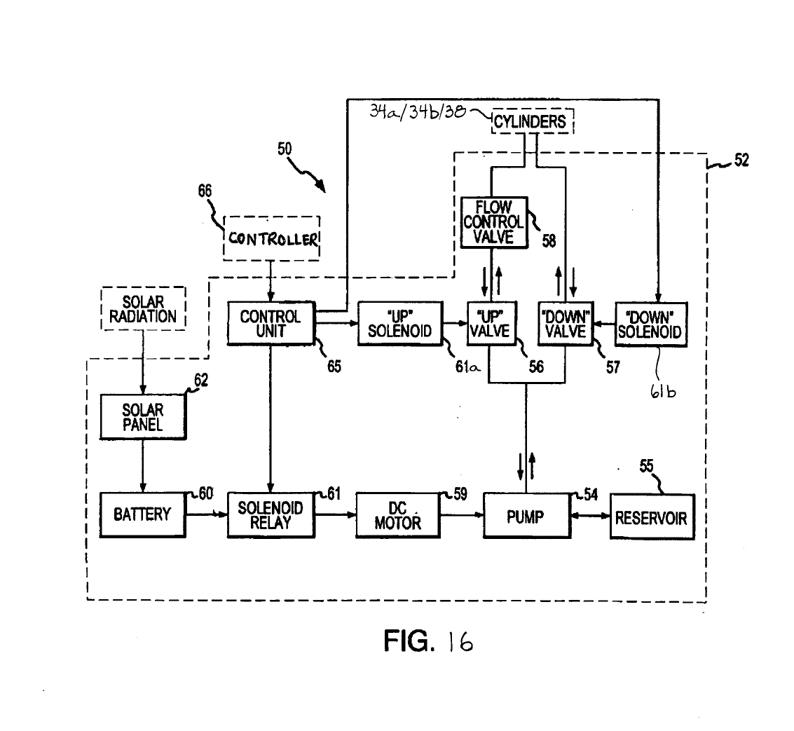

An alternative embodiment of the trailer (13) is shown in FIG. 15 which uses only a single wheel (41) attached to the distal end of the left side wheel support (32a) but to avoid contact with the left side frame member (14a), the wheel is cantilever mounted to an outward side of the left side wheel support such that when the left side hydraulically actuated cylinder (34a) is operated to rotate the left side wheel support fully rearward, the wheel will be positioned to an outward side of the left side frame member. Similarly, this embodiment uses only a single wheel (41) attached to the distal end of the right side wheel support (32b) but to avoid contact with the right side frame member (14b), the wheel is cantilever mounted to an outward side of the right side wheel support such that when the right side hydraulically actuated cylinder (34b) is operated to rotate the right side wheel support fully rearward, the wheel will be positioned to an outward side of the right side frame member. In such manner, the left and right side hydraulically actuated cylinders (34a and 34b) can be operated to lower the rearward end portion of the frame structure of the trailer to the lowest possible minimum lowered position.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A trailer for supporting a payload and being attached to a tow vehicle, comprising:
left and right side rigid, non-pivoting elongated frame members, each having forward and rearward ends with a middle portion extending therebetween, the left and right side frame members being spaced apart and disconnected along their middle portions and rearward ends;
a forward frame member having the forward ends of the left and right side frame members rigidly attached thereto;
left and right side downwardly extending wheel supports, each having upper and lower ends, the upper end of the left side wheel support being pivotally attached to the left side frame member rearward of the forward portion thereof and the upper end of the right side wheel support being pivotally attached to the right side frame member rearward of the forward portion thereof;
at least one left side wheel rotatably attached to the lower end of the left side wheel support;
at least one right side wheel rotatably attached to the lower end of the right side wheel support;
a left side bunk attached to the left side frame member in a position to engage the payload when being supported by the trailer;
a right side bunk attached to the right side frame member in a position to engage the payload when being supported by the trailer;
a tongue having forward and rearward ends, the rearward end being pivotally attached to the forward frame member, and the forward end configured for removable attachment to the tow vehicle;
a left side hydraulically actuated cylinder having first and second members extendable and retractable relative to the other, the first member being attached to the left side wheel support and the second member being attached to the left side frame member rearward of the forward portion thereof such that one of extension and retraction of the first and second members relative to the other causes rotation of the left side wheel support away from a portion of the left side frame member thereabove and lifting of the left side frame member, and the other of extension and retraction of the first and second members relative to the other causes rotation of the left side wheel support toward the portion of the left side frame member thereabove and lowering of the left side frame member;
a right side hydraulically actuated cylinder having first and second members extendable and retractable relative to the other, the first member being attached to the right side wheel support and the second member being attached to the right side frame member rearward of the forward portion thereof such that one of extension and retraction of the first and second members relative to the other causes rotation of the right side wheel support away from a portion of the right side frame member thereabove and lifting of the right side frame member, and the other of extension and retraction of the first and second members relative to the other causes rotation of the right side wheel support toward the portion of the right side frame member thereabove and lowering of the right side frame member;
a forward hydraulically actuated cylinder having first and second members extendable and retractable relative to the other, the first member being attached to the tongue and the second member being attached to the forward frame member such that one of extension and retraction of the first and second members relative to the other causes rotation of the tongue downward relative to the forward frame member and lifting of the forward frame member when the forward end of the tongue is attached to the tow vehicle, and the other of extension and retraction of the first and second members relative to the other causes rotation of the tongue upward and lowering of the forward frame member when the forward end of the tongue is attached to the tow vehicle; and
a self-contained and pressurized hydraulic fluid system attached to the forward frame member and operable independent of any external supply of pressurized hydraulic fluid, the hydraulic fluid system being operatively connected to the left and right side hydraulically actuated cylinders and the forward hydraulically actuated cylinder to selectively supply pressurized hydraulic fluid thereto for selective extension and retraction of the first and second members thereof relative to the other.

2. The trailer of claim 1 further including a support stand attached to the forward frame member and extending downward to a position to support the forward frame member above the ground when the forward end of the tongue is detached from the tow vehicle.

3. The trailer of claim 1 for use when the payload is a floating watercraft lift having left and right side floats, further including:
left and right side guides for positioning of the watercraft lift on the left and right side frame members at a desired watercraft lift location, the left side guide being attached to the left side frame member in a position adjacent to and inward of the left side float when the watercraft lift is at the desired watercraft lift location and the right side guide being attached to the right side frame member in a position adjacent to and inward of the right side float when the watercraft lift is at the desired watercraft lift location.

4. The trailer of claim 3 for further use when the payload is a watercraft supported on the left and right side bunks at a desired watercraft location, wherein the left side guide is pivotally attached to the left side frame member for selective rotation to a position out of contact with the watercraft when the watercraft is supported on the left and right side bunks at the desired watercraft location, and the right side guide is pivotally attached to the right side frame member for selective rotation to a position out of contact with the watercraft when the watercraft is supported on the left and right side bunks at the desired watercraft location.

5. The trailer of claim 4 for use whether the watercraft is a V-hull boat with a single bow or a catamaran hull boat with spaced-apart left and right side bows, further including a bow stop attached to the forward frame member, the bow stop including a transversely extending member having a central forwardly projecting and rearwardly portion defining a central recess opening rearwardly and sized to receive therein the bow of the V-hull boat for engagement of the bow stop central portion therewith, and left and right side forwardly projecting and rearwardly portions defining left and right side recesses opening rearwardly and sized and spaced apart on opposite sides of the central recess to receive therein the spaced-apart left and right bows, respectively, of the catamaran hull boat for engagement of the bow stop left and right portions therewith.

6. The trailer of claim 5 wherein the bow stop has left and right side support members attached to the transverse member, and the left and right side support members are pivotally attached to the forward frame member for selectively pivoting between a rearwardly extending position for engagement by the watercraft if having a first size and a forwardly extending position for engagement by the watercraft if having a second size larger than the first size.

7. The trailer of claim 5 further including a longitudinally extending track attached to the forward frame member, and wherein the bow stop has a support member with an upper end attached to the transverse member and a lower end slidably received in the track for selectively moving the bow stop forward and rearward to a desired position for engagement with the watercraft so as to accommodate watercraft of different sizes supported on the left and right side bunks.

8. The trailer of claim 3 further including a solar power source to provide electric power to the hydraulic fluid system.

9. The trailer of claim 8 wherein the hydraulic fluid system includes a hydraulic pump and an electric motor that drives the hydraulic pump, and further includes a battery that powers the electric motor, and the solar power source is a solar panel for providing charge to the battery.

10. The trailer of claim 1 further including a solar power source to provide electric power to the hydraulic fluid system.

11. The trailer of claim 10 wherein the hydraulic fluid system includes a hydraulic pump and an electric motor that drives the hydraulic pump, and further includes a battery that powers the electric motor, and the solar power source is a solar panel for providing charge to the battery.

12. The trailer of claim 10 for use whether the watercraft is a V-hull boat with a single bow or a catamaran hull boat with spaced-apart left and right side bows, further including a bow stop attached to the forward frame member, the bow stop including a transversely extending member having a central forwardly projecting and rearwardly portion defining a central recess opening rearwardly and sized to receive therein the bow of the V-hull boat for engagement of the bow stop central portion therewith, and left and right side forwardly projecting and rearwardly portions defining left and right side recesses opening rearwardly and sized and spaced apart on opposite sides of the central recess to receive therein the spaced-apart left and right bows, respectively, of the catamaran hull boat for engagement of the bow stop left and right portions therewith.

13. The trailer of claim 12 wherein the bow stop has left and right side support members attached to the transverse member, and the left and right side support members are pivotally attached to the forward frame member for selectively pivoting between a rearwardly extending position for engagement by the watercraft if having a first size and a forwardly extending position for engagement by the watercraft if having a second size larger than the first size.

14. The trailer of claim 12 further including a longitudinally extending track attached to the forward frame member, and wherein the bow stop has a support member with an upper end attached to the transverse member and a lower end slidably received in the track for selectively moving the bow stop forward and rearward to a desired position for engagement with the watercraft so as to accommodate watercraft of different sizes supported on the left and right side bunks.

15. The trailer of claim 1 for use whether the watercraft is a V-hull boat with a single bow or a catamaran hull boat with spaced-apart left and right side bows, further including a bow stop attached to the forward frame member, the bow stop including a transversely extending member having a central forwardly projecting and rearwardly portion defining a central recess opening rearwardly and sized to receive therein the bow of the V-hull boat for engagement of the bow stop central portion therewith, and left and right side forwardly projecting and rearwardly portions defining left and right side recesses opening rearwardly and sized and spaced apart on opposite sides of the central recess to receive therein the spaced-apart left and right bows, respectively, of the catamaran hull boat for engagement of the bow stop left and right portions therewith.

16. The trailer of claim 15 wherein the bow stop has left and right side support members attached to the transverse member, and the left and right side support members are pivotally attached to the forward frame member for selectively pivoting between a rearwardly extending position for engagement by the watercraft if having a first size and a forwardly extending position for engagement by the watercraft if having a second size larger than the first size.

17. The trailer of claim 15 further including a longitudinally extending track attached to the forward frame member, and wherein the bow stop has a support member with an upper end attached to the transverse member and a lower end slidably received in the track for selectively moving the bow stop forward and rearward to a desired position for engagement with the watercraft so as to accommodate watercraft of different sizes supported on the left and right side bunks.

18. The trailer of claim 1 for use whether the watercraft is a V-hull boat with a single bow or a catamaran hull boat with spaced-apart left and right side bows, further including a bow stop attached to the forward frame member, the bow stop including a transversely extending member having a central forwardly projecting and rearwardly portion defining a central recess opening rearwardly and sized to receive therein the bow of the V-hull boat for engagement of the bow stop central portion therewith, and left and right side forwardly projecting and rearwardly portions defining left and right side recesses opening rearwardly and sized and spaced apart on opposite sides of the central recess to receive therein the spaced-apart left and right bows, respectively, of the catamaran hull boat for engagement of the bow stop left and right portions therewith, and wherein the bow stop is longitudinally adjustable for selectively moving the bow stop forward and rearward to a desired position for engagement with the watercraft so as to accommodate watercraft of different sizes supported on the left and right side bunks.

19. The trailer of claim 1 wherein the hydraulic fluid system is operatively connected to the left and right side hydraulically actuated cylinders to synchronously operate the left and right side hydraulically actuated cylinders to simultaneously rotate the left and right side wheel supports in the same direction.

20. The trailer of claim 1 for use when the payload is a floating watercraft lift with a transversely extending cross-beam and supported on the left and right side bunks at a desired watercraft lift location, further including a transversely extending left side receiver member attached to the left side frame member and defining a transversely extending recess sized to receive the watercraft lift cross-beam therein, and a transversely extending right side receiver member attached to the right side frame member and defining a transversely extending recess sized to receive the watercraft lift cross-beam therein.

21. The trailer of claim 1 further including a handheld controller operable by a user and operatively connected to the hydraulic fluid system to provide user selected commands to the hydraulic fluid system, and wherein the hydraulic fluid system supplies pressurized hydraulic fluid to user selected ones of the left and right side hydraulically actuated cylinders and the forward hydraulically actuated cylinder in response to the user selected commands.

22. The trailer of claim 21 wherein the handheld controller provides the user selected commands to the hydraulic fluid system via a wireless link.

23. The trailer of claim 1 wherein the at least one left side wheel rotatably attached to the lower end of the left side wheel support includes a pair of left side wheels spaced-apart by a distance sufficient to straddle the left side frame member and thereby avoid their contact with the left side frame member when the left side wheel support is rotated toward the portion of the left side frame member thereabove by operation of the left side hydraulically actuated cylinder, and the at least one right side wheel rotatably attached to the lower end of the right side wheel support includes a pair of right side wheels spaced-apart by a distance sufficient to straddle the right side frame member and thereby avoid their contact with the right side frame member when the right side wheel support is rotated toward the portion of the right side frame member thereabove by operation of the right side hydraulically actuated cylinder.

24. The trailer of claim 1 wherein the at least one left side wheel rotatably attached to the lower end of the left side wheel support includes only a single left side wheel located laterally outward of the left side wheel support by a distance sufficient to avoid its contact with the left side frame member when the left side wheel support is rotated toward the portion of the left side frame member thereabove by operation of the left side hydraulically actuated cylinder, and the at least one right side wheel rotatably attached to the lower end of the right side wheel support includes only a single right side wheels located laterally outward of the right side wheel support by a distance sufficient to avoid its contact with the right side frame member when the right side wheel support is rotated toward the portion of the right side frame member thereabove by operation of the right side hydraulically actuated cylinder.

25. The trailer of claim 1 for use when the payload is a watercraft supported on the left and right side bunks whether the watercraft is a V-hull boat with a single hull or a catamaran hull boat with spaced-apart left and right side hulls, wherein the left and right side bunks each have a substantially flat, downwardly and outward sloping laterally outward facing watercraft-support surface and a substantially flat, downwardly and inward sloping laterally inward facing watercraft-support surface, the downwardly and inward sloping laterally inward facing watercraft-support surfaces of the left and right side bunks being positioned to supportingly contact the hull of the V-hull boat when supported on the left and right side bunks, and the downwardly and outward sloping laterally outward facing watercraft-support surfaces of the left and right side bunks being positioned to supportingly contact the left and right side hulls, respectively, of the catamaran hull boat when supported on the left and right side bunks.

26. The trailer of claim 1 wherein the forward end of the left side frame member extends forwardly and angles inward and the forward end of the right side frame member extends forwardly and angle inward, and the forward frame member has rearwardly extending left and right side members, the left side member angles outward at the same angle as the forward end of the left side frame member and the right side member angles outward at the same angle as the forward end of the right side frame member, with the forward end of the left side frame member and the rearwardly extending left side member of the forward frame member being in telescopic adjustable engagement and selectively lockable together against movement therebetween, and the forward end of the right side frame member and the rearwardly extending right side member of the forward frame member being in telescopic adjustable engagement and selectively lockable together against movement therebetween, whereby the spacing between the left and right side frame members is selectively adjustable.

27. A trailer for supporting a payload and being attached to a tow vehicle, comprising:
a trailer frame including left and right side rigid, non-pivoting elongated frame members, each having forward and rearward ends with a middle portion extending therebetween, the left and right side frame members being spaced apart and disconnected along their middle portions and rearward ends, and a forward frame member having the forward ends of the left and right side frame members attached thereto;
left and right side downwardly extending wheel supports, each having upper and lower ends, the upper end of the left side wheel support being pivotally attached to the left side frame member rearward of the forward portion thereof and the upper end of the right side wheel support being pivotally attached to the right side frame member rearward of the forward portion thereof;
at least one left side wheel rotatably attached to the lower end of the left side wheel support;
at least one right side wheel rotatably attached to the lower end of the right side wheel support;
a left side bunk attached to the left side frame member in a position to engage the payload when being supported by the trailer;
a right side bunk attached to the right side frame member in a position to engage the payload when being supported by the trailer;
a tongue having forward and rearward ends, the rearward end being pivotally attached to the trailer frame at a forward portion thereof, and the forward end configured for removable attachment to the tow vehicle;
a left side hydraulically actuated actuator for selectively rotating the left side wheel support relative to the trailer frame upward and downward to lift and lower the left side frame member;
a right side hydraulically actuated actuator for selectively rotating the right side wheel support relative to the trailer frame upward and downward to lift and lower the right side frame member;
a forward hydraulically actuated actuator for selectively rotating the tongue relative to the trailer frame upward and downward to lift and lower the forward frame member when the forward end of the tongue is attached to the tow vehicle, and to lift and lower the forward end of the tongue relative forward frame member when the forward end of the tongue is detached from the tow vehicle; and
a self-contained and pressurized hydraulic fluid system attached to the trailer frame and operable independent of any external supply of pressurized hydraulic fluid, the hydraulic fluid system being operatively connected to the left and right side hydraulically actuated actuators and the forward hydraulically actuated actuator to selectively supply pressurized hydraulic fluid thereto.

28. The trailer of claim 27 further including a support stand attached to the trailer frame and extending downward to a position to support the forward frame member above the ground when the forward end of the tongue is detached from the tow vehicle.

29. The trailer of claim 27 for use when the payload is a floating watercraft lift having left and right side floats, further including:
left and right side guides for positioning of the watercraft lift on the left and right side frame members at a desired watercraft lift location, the left side guide being attached to the trailer frame in a position adjacent to and inward of the left side float when the watercraft lift is at the desired watercraft lift location and the right side guide being attached to the trailer frame in a position adjacent to and inward of the right side float when the watercraft lift is at the desired watercraft lift location.

30. The trailer of claim 29 for further use when the payload is a watercraft supported on the left and right side bunks at a desired watercraft location, wherein the left side guide is movably attached to the trailer frame for selective movement to a position out of contact with the watercraft when the watercraft is supported on the left and right side bunks at the desired watercraft location, and the right side guide is movably attached to the trailer frame for selective movement to a position out of contact with the watercraft when the watercraft is supported on the left and right side bunks at the desired watercraft location.

31. The trailer of claim 30 for use whether the watercraft is a V-hull boat with a single bow or a catamaran hull boat with spaced-apart left and right side bows, further including a bow stop attached to the trailer frame, the bow stop including a transversely extending member having a central forwardly projecting and rearwardly portion defining a central recess opening rearwardly and sized to receive therein the bow of the V-hull boat for engagement of the bow stop central portion therewith, and left and right side forwardly projecting and rearwardly portions defining left and right side recesses opening rearwardly and sized and spaced apart on opposite sides of the central recess to receive therein the spaced-apart left and right bows, respectively, of the catamaran hull boat for engagement of the bow stop left and right portions therewith.

32. The trailer of claim 31 wherein the bow stop has left and right side support members attached to the transverse member, and the left and right side support members are pivotally attached to the trailer frame for selectively pivoting between a rearwardly extending position for engagement by the watercraft if having a first size and a forwardly extending position for engagement by the watercraft if having a second size larger than the first size.

33. The trailer of claim 31 further including a longitudinally extending track attached to the trailer frame, and wherein the bow stop has a support member with an upper end attached to the transverse member and a lower end slidably received in the track for selectively moving the bow stop forward and rearward to a desired position for engagement with the watercraft so as to accommodate watercraft of different sizes supported on the left and right side bunks.

34. The trailer of claim 27 further including a solar power source to provide electric power to the hydraulic fluid system.

35. The trailer of claim 34 wherein the hydraulic fluid system includes a hydraulic pump and an electric motor that drives the hydraulic pump, and further includes a battery that powers the electric motor, and the solar power source is a solar panel for providing charge to the battery.

36. The trailer of claim 27 for use whether the watercraft is a V-hull boat with a single bow or a catamaran hull boat with spaced-apart left and right side bows, further including a bow stop attached to the forward frame member, the bow stop including a transversely extending member having a central forwardly projecting and rearwardly portion defining a central recess opening rearwardly and sized to receive therein the bow of the V-hull boat for engagement of the bow stop central portion therewith, and left and right side forwardly projecting and rearwardly portions defining left and right side recesses opening rearwardly and sized and spaced apart on opposite sides of the central recess to receive therein the spaced-apart left and right bows, respectively, of the catamaran hull boat for engagement of the bow stop left and right portions therewith.

37. The trailer of claim 36 wherein the bow stop has left and right side support members attached to the transverse member, and the left and right side support members are pivotally attached to the trailer frame for selectively pivoting between a rearwardly extending position for engagement by the watercraft if having a first size and a forwardly extending position for engagement by the watercraft if having a second size larger than the first size.

38. The trailer of claim 36 further including a longitudinally extending track attached to the trailer frame, and wherein the bow stop has a support member with an upper end attached to the transverse member and a lower end slidably received in the track for selectively moving the bow stop forward and rearward to a desired position for engagement with the watercraft so as to accommodate watercraft of different sizes supported on the left and right side bunks.

39. The trailer of claim 27 wherein the hydraulic fluid system is operatively connected to the left and right side hydraulically actuated actuators to synchronously operate the left and right side hydraulically actuated actuators to simultaneously rotate the left and right side wheel supports in the same direction.

40. The trailer of claim 27 for use when the payload is a floating watercraft lift with a transversely extending cross-beam and supported on the left and right side bunks at a desired watercraft lift location, further including a transversely extending left side receiver member attached to the left side frame member and defining a transversely extending recess sized to receive the watercraft lift cross-beam therein, and a transversely extending right side receiver member attached to the right side frame member and defining a transversely extending recess sized to receive the watercraft lift cross-beam therein.

41. The trailer of claim 27 further including a handheld controller operable by a user and operatively connected to the hydraulic fluid system to provide user selected commands to the hydraulic fluid system, and wherein the hydraulic fluid system supplies pressurized hydraulic fluid to user selected ones of the left and right side hydraulically actuated actuators and the forward hydraulically actuated actuator in response to the user selected commands.

42. The trailer of claim 27 for use when the payload is a watercraft supported on the left and right side bunks whether the watercraft is a V-hull boat with a single hull or a catamaran hull boat with spaced-apart left and right side hulls, wherein the left and right side bunks each have a substantially flat, downwardly and outward sloping laterally outward facing watercraft-support surface and a substantially flat, downwardly and inward sloping laterally inward facing watercraft-support surface, the downwardly and inward sloping laterally inward facing watercraft-support surfaces of the left and right side bunks being positioned to supportingly contact the hull of the V-hull boat when supported on the left and right side bunks, and the downwardly and outward sloping laterally outward facing watercraft-support surfaces of the left and right side bunks being positioned to supportingly contact the left and right side hulls, respectively, of the catamaran hull boat when supported on the left and right side bunks.

43. The trailer of claim 27 wherein the forward end of the left side frame member extends forwardly and angles inward and the forward end of the right side frame member extends forwardly and angle inward, and the forward frame member has rearwardly extending left and right side members, the left side member angles outward at the same angle as the forward end of the left side frame member and the right side member angles outward at the same angle as the forward end of the right side frame member, with the forward end of the left side frame member and the rearwardly extending left side member of the forward frame member being in telescopic adjustable engagement and selectively lockable together against movement therebetween, and the forward end of the right side frame member and the rearwardly extending right side member of the forward frame member being in telescopic adjustable engagement and selectively lockable together against movement therebetween, whereby the spacing between the left and right side frame members is selectively adjustable.

44. A trailer for supporting a payload and being attached to a tow vehicle, comprising:
a trailer frame including left and right side rigid, non-pivoting elongated frame members, each having forward and rearward ends with a middle portion extending therebetween, the left and right side frame members being spaced apart and disconnected along their middle portions and rearward ends, and a forward frame member having the forward ends of the left and right side frame members attached thereto;
left and right side downwardly extending wheel supports, each having upper and lower ends, the upper end of the left side wheel support being movably attached to the left side frame member rearward of the forward portion thereof and the upper end of the right side wheel support being movably attached to the right side frame member rearward of the forward portion thereof;
at least one left side wheel rotatably attached to the lower end of the left side wheel support;
at least one right side wheel rotatably attached to the lower end of the right side wheel support;
a left side bunk attached to the left side frame member in a position to engage the payload when being supported by the trailer;
a right side bunk attached to the right side frame member in a position to engage the payload when being supported by the trailer;
a tongue having forward and rearward ends, the rearward end being movably attached to the trailer frame at a forward portion thereof, and the forward end configured for removable attachment to the tow vehicle;
a left side actuator for selectively moving the left side wheel support relative to the trailer frame upward and downward to lift and lower the left side frame member;
a right side actuator for selectively moving the right side wheel support relative to the trailer frame upward and downward to lift and lower the right side frame member;
a forward actuator for selectively moving the tongue relative to the trailer frame upward and downward to lift and lower the forward frame member when the forward end of the tongue is attached to the tow vehicle, and to lift and lower the forward end of the tongue relative forward frame member when the forward end of the tongue is detached from the tow vehicle; and
a power system attached to the trailer frame and being operatively connected to the left and right side actuators and the forward actuator to selectively supply power thereto for operation thereof.

45. The trailer of claim 44 for use when the payload is a floating watercraft lift having left and right side floats, further including:
left and right side guides for positioning of the watercraft lift on the left and right side frame members at a desired watercraft lift location, the left side guide being attached to the trailer frame in a position adjacent to and inward of the left side float when the watercraft lift is at the desired watercraft lift location and the right side guide being attached to the trailer frame in a position adjacent to and inward of the right side float when the watercraft lift is at the desired watercraft lift location.

46. The trailer of claim 45 for further use when the payload is a watercraft supported on the left and right side bunks at a desired watercraft location, wherein the left side guide is movably attached to the trailer frame for selective movement to a position out of contact with the watercraft when the watercraft is supported on the left and right side bunks at the desired watercraft location, and the right side guide is movably attached to the trailer frame for selective movement to a position out of contact with the watercraft when the watercraft is supported on the left and right side bunks at the desired watercraft location.

47. The trailer of claim 44 for use whether the watercraft is a V-hull boat with a single bow or a catamaran hull boat with spaced-apart left and right side bows, further including a bow stop attached to the forward frame member, the bow stop including a transversely extending member having a central forwardly projecting and rearwardly portion defining a central recess opening rearwardly and sized to receive therein the bow of the V-hull boat for engagement of the bow stop central portion therewith, and left and right side forwardly projecting and rearwardly portions defining left and right side recesses opening rearwardly and sized and spaced apart on opposite sides of the central recess to receive therein the spaced-apart left and right bows, respectively, of the catamaran hull boat for engagement of the bow stop left and right portions therewith.

48. The trailer of claim 47 wherein the bow stop has left and right side support members attached to the transverse member, and the left and right side support members are pivotally attached to the trailer frame for selectively pivoting between a rearwardly extending position for engagement by the watercraft if having a first size and a forwardly extending position for engagement by the watercraft if having a second size larger than the first size.

49. The trailer of claim 47 further including a longitudinally extending track attached to the trailer frame, and wherein the bow stop has a support member with an upper end attached to the transverse member and a lower end slidably received in the track for selectively moving the bow stop forward and rearward to a desired position for engagement with the watercraft so as to accommodate watercraft of different sizes supported on the left and right side bunks.

50. The trailer of claim 44 for use when the payload is a floating watercraft lift with a transversely extending cross-beam and supported on the left and right side bunks at a desired watercraft lift location, further including a transversely extending left side receiver member attached to the left side frame member and defining a transversely extending recess sized to receive the watercraft lift cross-beam therein, and a transversely extending right side receiver member attached to the right side frame member and defining a transversely extending recess sized to receive the watercraft lift cross-beam therein.

51. A method of retrieving a floating payload from the water and moving the payload up a ramp using a trailer having a frame with bunks attached thereto to engage and support the payload, the trailer including left and right side downwardly extending wheel supports pivotally attached to a rearward portion of the frame and each having at least one wheel rotatably attached thereto, and a tongue pivotally attached to a forward portion of the frame for upward and downward movement and having a forward end configured for attachment to a tow vehicle, the trailer further having left and right side actuators to selectively rotate the left and right side wheel supports upward and downward to lower and lift the rearward portion of the frame, and a forward actuator to selectively rotate the tongue upward and downward to lower and lift the forward portion of the frame when the forward end of the tongue is attached to the tow vehicle, comprising:
positioning the trailer in the water with the bunks under the payload by using the tow vehicle to move the trailer;
operating at least the left and right side actuators to rotate the left and right side wheel supports downward to lift the rearward portion of the frame and bring the bunks into supporting engagement with the payload;
moving the tow vehicle forward to pull the trailer up the ramp without tying the payload to the trailer; and
operating selected ones of the left and right side actuators and the forward actuator to lower or lift the rearward and forward portions of the frame as necessary to maintain the bunks in an orientation preventing the payload from moving off the bunks without tying the payload to the trailer as the trailer is pulled up the ramp by the tow vehicle.

52. The method of claim 51 for use where the ramp has an apex, further including prior to the forward portion of the frame reaching the apex of the ramp as a result of being pulled up the ramp by the tow vehicle, operating the forward actuator to lift the forward portion of the frame as necessary to increase the ground clearance of the forward portion of the frame to avoid contact of the trailer frame with the apex of the ramp.

53. A method of positioning a payload on at least one block using a trailer having a frame with bunks attached thereto to engage and support the payload, the trailer including left and right side downwardly extending wheel supports pivotally attached to a rearward portion of the frame and each having at least one wheel rotatably attached thereto, and a tongue pivotally attached to a forward portion of the frame for upward and downward movement and having a forward end configured for attachment to a tow vehicle, the trailer further having left and right side actuators to selectively rotate the left and right side wheel supports upward and downward to lower and lift the rearward portion of the frame, and a forward actuator to selectively rotate the tongue upward and downward to lower and lift the forward portion of the frame when the forward end of the tongue is attached to the tow vehicle, comprising:
positioning the trailer over the at least one block with the bunks in supporting engagement with the payload by using the tow vehicle to move the trailer;
operating selected ones of the left and right side actuators and the forward actuator to lower the rearward and forward portions of the frame as necessary to move the payload downward into supporting contact with the at least one block;
operating selected ones of the left and right side actuators and the forward actuator to further lower the rearward and forward portions of the frame as necessary to move the bunks out of engagement with the payload and provide sufficient clearance between the payload and the trailer that the trailer can be pulled forward by the tow vehicle with the payload remaining supported on the at least one block; and
towing the trailer forward with the tow vehicle from under the payload.

54. The method of claim 53 for use to lift the payload off of at least one block, further including:
positioning the trailer with the bunks under the payload by using the tow vehicle to move the trailer;
operating selected ones of the left and right side actuators and the forward actuator to lift the rearward and forward portions of the frame as necessary to move the bunks upward into supporting engagement with the payload;
operating selected ones of the left and right side actuators and the forward actuator to further lift the rearward and forward portions of the frame as necessary to move the payload off of the at least one block and provide sufficient clearance between the payload and the at least one block that the trailer can be pulled forward by the tow vehicle with the payload on the bunks without the payload or the trailer contacting the at least one block; and
towing the trailer forward with the tow vehicle away from the at least one block.

55. A method of positioning a payload for storage when the payload has downwardly extendable support legs using a trailer having a frame with bunks attached thereto to engage and support the payload, the trailer including left and right side downwardly extending wheel supports pivotally attached to a rearward portion of the frame and each having at least one wheel rotatably attached thereto, and a tongue pivotally attached to a forward portion of the frame for upward and downward movement and having a forward end configured for attachment to a tow vehicle, the trailer further having left and right side actuators to selectively rotate the left and right side wheel supports upward and downward to lower and lift the rearward portion of the frame, and a forward actuator to selectively rotate the tongue upward and downward to lower and lift the forward portion of the frame when the forward end of the tongue is attached to the tow vehicle, comprising:
positioning the trailer at the desired location for storage of the payload with the bunks in supporting engagement with the payload by using the tow vehicle to move the trailer;
extending downward the support legs of the payload;
operating selected ones of the left and right side actuators and the forward actuator to lower the rearward and forward portions of the frame as necessary to move the payload downward to engage the downwardly extending support legs of the payload with the ground and to further lower the rearward and forward portions of the frame as necessary to move the bunks out of engagement with the payload and provide sufficient clearance between the payload and the trailer that the trailer can be pulled forward by the tow vehicle with the payload remaining supported by the downwardly extending support legs of the payload at the desired location for storage; and
towing the trailer forward with the tow vehicle from under the payload.

56. A method of disconnecting a trailer from a tow vehicle when the trailer has a frame supported by left and right side rear wheels, and the trailer includes a tongue pivotally attached to a forward portion of the frame for upward and downward movement and having a forward end configured for removable and lockable attachment to the tow vehicle, the trailer further having an adjustable support member attached to the forward portion of the frame and a forward actuator to selectively rotate the tongue upward and downward relative to the forward portion of the frame, comprising:
positioning the trailer at a desired location for removal of the trailer from the tow vehicle by using the tow vehicle to move the trailer;
moving the support member downward;
operating the forward actuator to rotate the tongue upward to lower the forward portion of the frame when the forward end of the tongue is attached to the tow vehicle as necessary to engage the support member with the ground;
unlocking the forward end of the tongue from the tow vehicle; and
operating the forward actuator to further rotate the tongue upward to detach the forward end of the tongue from the tow vehicle.

57. A method of claim 56 for use reconnect the trailer to the tow vehicle, further including:
positioning the tow vehicle at the location of the trailer with the tow vehicle in position to have the forward end of the tongue attached to the tow vehicle;
operating the forward actuator to rotate the tongue downward to a position for attachment of the forward end of the tongue to the tow vehicle;
attaching the forward end of the tongue to the tow vehicle; and
operating the forward actuator to further rotate the tongue downward to substantially unweight the downward force on the support member; and
moving the support member upward.
